(19) United States
(12) Patent Application Publication
(10) Pub. No.: US 2014/0233618 A1
(43) Pub. Date: Aug. 21, 2014

(54) METHOD AND APPARATUS FOR SELF-TESTING TO IMPROVE FACTORY THROUGHPUT

(71) Applicant: QUALCOMM Incorporated, San Diego, CA (US)

(72) Inventors: Sudarsan KRISHNAN, San Diego, CA (US); Andrei V. IZOTOV, San Diego, CA (US)

(73) Assignee: QUALCOMM Incorporated, San Diego, CA (US)

(21) Appl. No.: 14/037,234

(22) Filed: Sep. 25, 2013

Related U.S. Application Data
(60) Provisional application No. 61/765,514, filed on Feb. 15, 2013.

(51) Int. Cl. H04B 17/00

(52) U.S. Cl. CPC H04B 17/0012
USPC 375/222

(57) ABSTRACT

A method and apparatus for self-testing of a radio frequency (RF) chipset is provided. The method requires that a set of test instructions be loaded into a software load station. Once the software is loaded, reference calibration is conducted with test equipment connected. After calibration, the test equipment is disconnected and self-testing of a transmit chain begins. A pre-determined load value is connected and the self-testing process routes a signal from the RF chipset internal modem through a power amplifier, duplexer, first coupler, switch, second coupler, and RF integrated circuit (IC). The apparatus includes a RF chipset that has an internal modem and signal generator as well as processors for processing self-testing of a transmit chain, self-testing of a primary receiver, and self-testing of a diversity receiver chain.

### CLAIM OF PRIORITY UNDER 35 U.S.C. §119

The present Application for Patent claims priority to Provisional Application No. 61/765,514, entitled “SELF TEST TO IMPROVE FACTORY THROUGHPUT” filed Feb. 15, 2013, and assigned to the assignee hereof and hereby expressly incorporated by reference herein.

### BACKGROUND

### Field

The present disclosure relates generally to wireless communication system. More specifically the present disclosure related to methods and apparatus for self-testing of chipsets to improve factory throughput.

### Background

As the use of mobile devices grows, so does the need to manufacture and test new devices in an efficient and cost-effective manner. Testing in the factory requires costly options on test equipment. In particular, transmission testing for mobile devices and chipsets requires that the test equipment be able to demodulate and decode the signal, further increasing the complexity of the equipment. Receive testing also adds complexity, as it requires that a signal generator be available to provide signals for testing reception.

A further problem with this testing is that testing reduces factory throughput capacity. The current testing philosophy provides for connecting the device or chipset to be tested to the test equipment, which is inefficient. With the current approach it is not possible to implement efficient pipeline testing methods.

There is a need in the art for methods and apparatus to improve factory throughput through the use of self-calibration and self-testing of chipsets.

### SUMMARY

Embodiments disclosed herein provide a method for self-testing of a radio frequency (RF) chipset. The method requires that a set of test instructions be loaded into a software load station. Once the software is loaded, reference calibration is conducted with test equipment connected. After calibration, the test equipment is disconnected and self-testing of a transmit chain begins. A pre-determined load value is connected and the self-testing process routes a signal from the RF chipset internal modem through a power amplifier, duplexer, first coupler, switch, second coupler, and RF integrated circuit (IC).

A further embodiment provides an apparatus for self-testing of a RF chipset. The apparatus includes an RF chipset to be tested, which has an internal modem and an internal signal generator. The apparatus further includes a processor for processing self-testing of a transmit chain and a processor for processing self-testing of a diversity receiver chain.

A still further embodiment provides an apparatus for an apparatus for self-testing of a RF chipset. The apparatus provides: means for loading a set of instructions into a software load station; means for conducting reference calibration with test equipment connected; means for disconnecting the test equipment and performing self-testing of a transmit chain with a predetermined load value connected, wherein the self-testing routes a signal from the RF chipset internal modem through a power amplifier, duplexer, first coupler, switch, second coupler, and RF integrated circuit.

An additional embodiment provides a computer-readable non-transitory storage medium containing instructions. The instructions cause a processor to perform the steps of: loading a set of instructions into a software loading station; conducting reference calibration with test equipment connected; after disconnecting the test equipment, performing self-testing of a transmit chain with a predetermined load value connected, wherein the self-testing routes a signal from the RF chipset internal modem through a power amplifier, duplexer, first coupler, switch, second coupler, and RF integrated circuit.

### BRIEF DESCRIPTION OF THE DRAWINGS

FIG. 1 depicts a block diagram of a method of self-testing transmit and receive paths within a RF chipset according to an embodiment.

FIG. 2 illustrates a flow diagram of a factory flow for self-testing and self-calibration accordance to an embodiment.

FIG. 3 is a flow diagram of a method for self-testing and self-calibration according to an embodiment.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as, but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

As used herein, the term “determining” encompasses a wide variety of actions and therefore, “determining” can include calculating, computing, processing, deriving, investigating, looking up (e.g., looking up in a table, a database or another data structure), ascertaining and the like. Also, “determining” can include resolving, selecting choosing, establishing, and the like.

The phrase “based on” does not mean “based only on,” unless expressly specified otherwise. In other words, the phrase “based on” describes both “based only on” and “based at least on.”

Moreover, the term “or” is intended to man an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The various illustrative logical blocks, modules, and circuits described in connection with the present disclosure may be implemented or performed with a general purpose processor, a digital signal processor (DSP), an application specific integrated circuit (ASIC), a field programmable gate array (FPGA), or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM, and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A computer-readable medium may be any available medium that can be accessed by a computer. By way of example, and not limitation, a computer-readable medium may comprise RAM, ROM, EEPROM, CD-ROM or other optical disk storage, magnetic disk storage, or other magnetic storage devices, or any other medium that can be used to carry or store desired program code in the form of instructions or data structures and that can be accessed by a computer. Disk and disc, as used herein, includes compact disk (CD), laser disk, optical disc, digital versatile disk (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

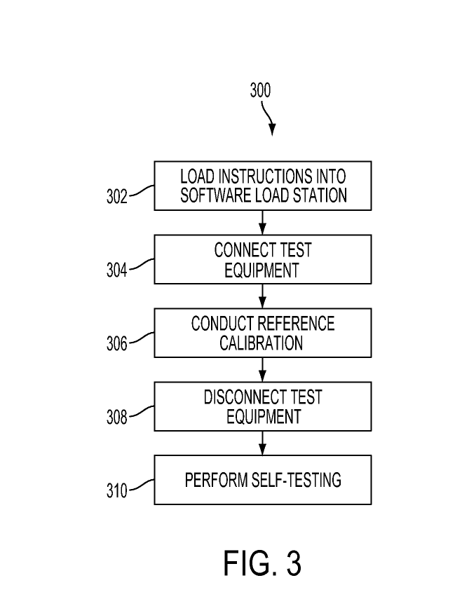

Further, it should be appreciated that modules and/or other appropriate means for performing the methods and techniques described herein, such as those illustrated by FIGS. 3-6, can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband CDMA (W-CDMA). CDMA2000 covers IS-2000, IS-95 and technology such as Global System for Mobile Communication (GSM).

An OFDMA network may implement a radio technology such as Evolved UTRA (E-UTRA), the Institute of Electrical and Electronics Engineers (IEEE) 802.11, IEEE 802.16, IEEE 802.20, Flash-OFDAM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3^{rd} Generation Partnership Project” (3GPP). CDMA2000 is described in documents from an organization named “3^{rd} Generation Partnership Project 2” (3GPP2). These various radio technologies and standards are known in the art. For clarity, certain aspects of the techniques are described below for LTE, and LTE terminology is used in much of the description below. It should be noted that the LTE terminology is used by way of illustration and the scope of the disclosure is not limited to LTE. Rather, the techniques described herein may be utilized in various application involving wireless transmissions, such as personal area networks (PANs), body area networks (BANs), location, Bluetooth, GPS, UWB, RFID, and the like. Further, the techniques may also be utilized in wired systems, such as cable modems, fiber-based systems, and the like.

Single carrier frequency division multiple access (SC-FDMA), which utilizes single carrier modulation and frequency domain equalization has similar performance and essentially the same overall complexity as those of an OFDMA system. SC-FDMA signal may have lower peak-to-average power ration (PAPR) because of its inherent single carrier structure. SC-FDMA may be used in the uplink communications where the lower PAPR greatly benefits the mobile terminal in terms of transmit power efficiency.

A method and apparatus for self-testing and self-calibration of a radio frequency (RF) chipset is provided by the embodiments described here. Many RF chipsets include a feedback receiver which can be used to capture the transmitted signal for analysis. To accomplish this, self-testing may be performed by moving all modulation and emissions testing into the feedback (FB) receiver. This allows for I and Q capture to occur and be processed on the mobile device. A modem controlling the RF chip is used to accomplish this. The data from the modem is received and analyzed during the self-testing process.

A possible factory flow for the process may proceed as follows. The software load station is provided with a software program that controls the self-testing. A reference calibration may then be performed, using current test equipment. Once the reference calibration is complete, the RF chipset is disconnected form the test equipment and a 50 ohm load is connected for the self-test process. Once the self-testing has been completed, the 50 ohm load is disconnected and the RF chipset proceeds to final testing. An advantage of the method is that the RF chipsets may be testing in parallel as no test equipment is used for the self-testing, only a load, such as the 50 ohm load, used as an example above. This provides for many more RF chipsets to be self-tested at the same time, and eliminates the bottlenecks that often occur as chipsets wait for test equipment to become available.

An alternate embodiment provides that all transmit testing may also be performed as part of a self-testing and self-calibration process on the chipset. Such transmit testing may incorporate the use of a computer program operating on a personal computer or other processor.

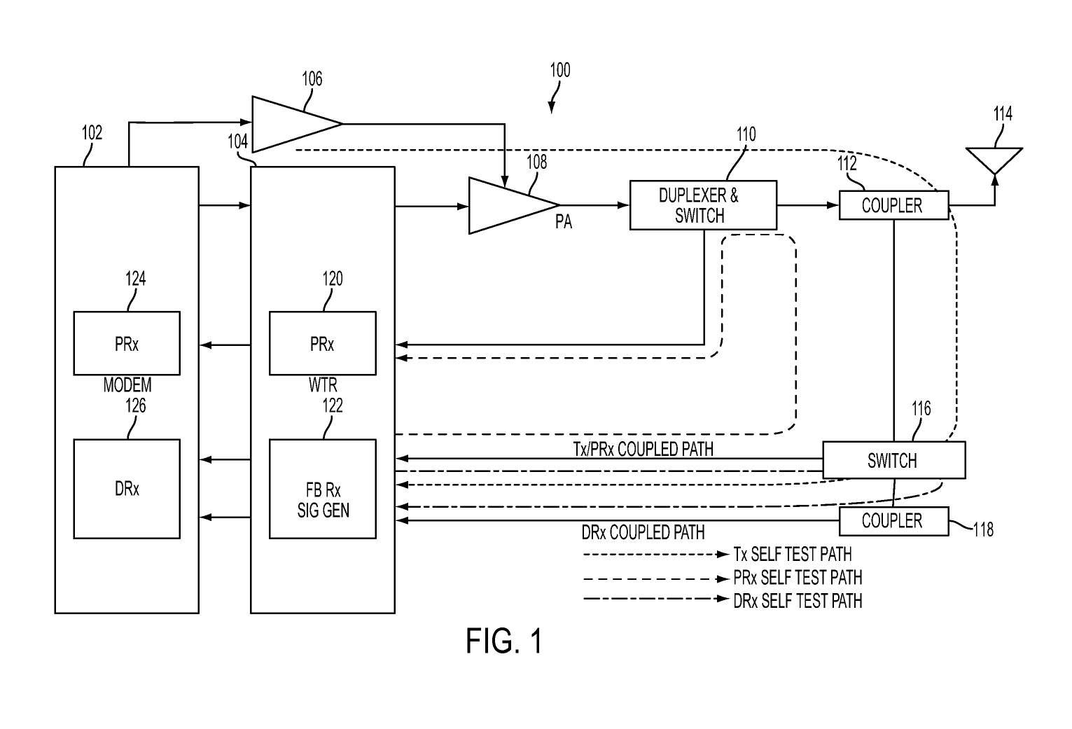

FIG. 1 illustrates the self-testing block diagram for the embodiments described briefly above. The transmit, or Tx test path process proceeds as illustrated by the path labeled Tx. The PRx self-test path is shown by the path labeled PRx, while the DRx test path follows the DRx labeled path.

In FIG. 1 the self-testing apparatus 100 incorporates a modem assembly 102, which incorporates a primary receiver (PRx) 124 and a diversity receiver (DRx) 126. WTR 104 incorporates a primary receiver (PRx) 120 and a signal generator, feedback receiver (FB Rx), and HDET 122. The modem 102 and WTR communicate with each other. PRx 120 in WTR 104 provides input to PRx 124 in modem 102. The signal generator, FB Rx, and HDET 122 provides two inputs to DRx 126. Modem 102 provides input to amplifier 106, while WTR 120 provides input to power amplifier (PA) 108. Amplifier 106 also has input to PA 108. PA 108 output is provided to duplexer and switch 110. Duplexer and switch 110 provides an input to the PRx 120 section of WTR 104 and also to a first coupler 112. Coupler 112 outputs a signal to antenna 114 and is also connected to switch 116. Switch 116 is connected to second coupler 118.

The block diagram of FIG. 1 also illustrates three self-test paths. The first self-test path is the transmit (Tx) self-test path. The Tx path begins with a signal sent from amplifier 106 through first coupler 112, switch 116, and from there into the HDET, FB Rx, signal generator 122. This selection of elements provides for a thorough test of the device's transmit capability without external test equipment.

A second test path illustrated in FIG. 1 is the primary receive or PRx test path. In this path a test signal is initiated at HDET, FB Rx, signal generator 122 and is routed through duplexer and switch 110 and from there to the PRx 120 section of the WTR 104. For both the Tx and PRx self-test paths PRx 120 may route the signal to PRx 102 within modem 102. HDET, FB Rx, signal generator 122 may route two signals to the DRx receiver 126 in modem 102. This path provides for a primary receiver signal to be tested without additional external test equipment.

A third test path is also depicted in FIG. 1 and is the diversity receiver test path. In this path a signal is initiated from HDET, FB Rx, signal generator 122 and is routed through switch 116 and second coupler 118. As noted above, HDET, FB Rx, signal generator 122 may also provide two signals to DRx 126 in the modem 102 as part of the diversity receive test path. This diversity test may offer savings in time and wear and tear on external test equipment as the diversity receive section of the device is tested without additional test equipment.

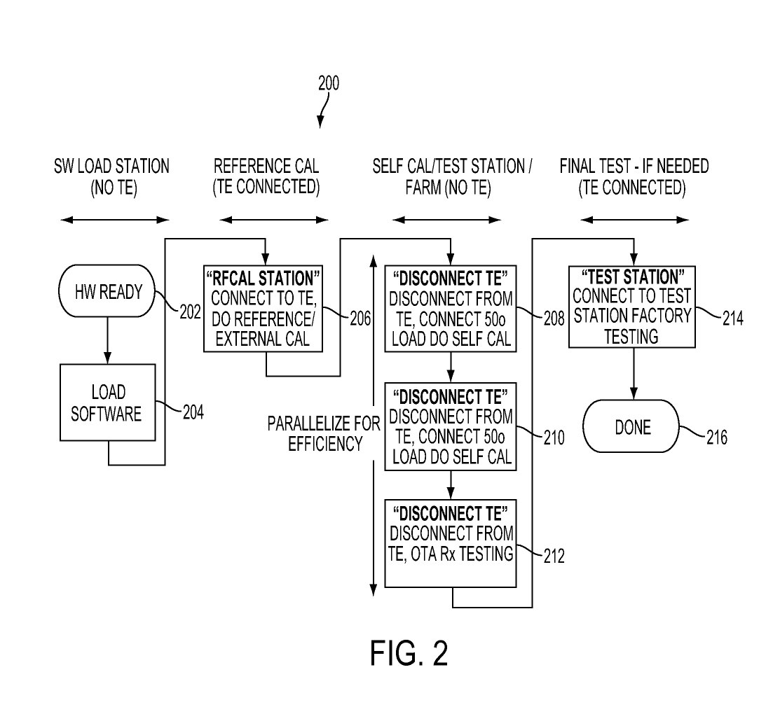

FIG. 2 depicts a possible factory flow using the embodiments described herein, with parallel paths provided for greater efficiency. This factory flow 200 provides for various test stations, beginning with a software load station that does not require test equipment. From the software load station devices to be test move to a reference calibration station, which does require external test equipment to be connected. Once reference calibration has been completed, devices move to the self-test and self-calibration station which does not require external test equipment. If needed, a final test process may be used, which does require test equipment to be connected to the device.

The factory flow 200 begins with the software load station. In step 202 the hardware is readied for the test. Software is loaded in step 204. At this point, the device moves from the software loading station to the reference calibration station, where test equipment is connected to the device. Here, reference calibration as well as any required external calibration is performed.

Once the reference calibration is completed the device moves to the self-test and self-calibration station. At this station, there is no external test equipment required. At step 208 any external test equipment is disconnected and a 50 ohm load, or other suitable load value is connected. Self-calibration is performed in step 208. The 50 ohm load, or other value if selected is also connected for the self-test process of step 210. In step 212 over the air (OTA) receiver testing is conducted. Steps 208, 210, and 212 may be parallelized for greater efficiency in the factory, with multiple devices undergoing self-calibration while others undergo self-testing, or OTA receive testing.

Once the self-calibration and self-testing is complete the devices may move to a final test station. At this final test station additional factory testing may be performed and this testing may require connecting external test equipment. The devices are connected to the test station and factory testing is performed in step 214. The factory flow concludes at step 216.

FIG. 3 provides a flow chart of a method for self-testing an RF chipset. The method, 300 begins when instructions for the self-testing are loaded into a software load station in step 302. Test equipment is connected to the RF chipset in step 304. A reference calibration is performed in step 306. Once the reference calibration of step 306 is concluded, the test equipment is disconnected in step 308. Self-testing is performed in step 310.

The self-testing of a transmit chain in step 310 is conducted with a predetermined load value connected. This predetermined load value may be 50 ohms for many RF chipsets, however, other values may be used depending on the chipset and the need for varying values during the self-testing process. During the self-test signals are routed from the RF chipset internal modem through a power amplifier 108, first coupler 112, switch 116, second coupler 118, and also through the RF integrated circuit (RF IC) chipset.

The methods and apparatus described herein allow for parallelization of testing and the efficient use of external test equipment to increase factory throughput. The RF IC chipsets may be self-tested and calibrated in a more cost effective manner, while still providing thorough testing.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for self-testing a radio frequency (RF) chipset, comprising:
loading a set of instructions into a software load station;
conducting reference calibration with test equipment connected;
disconnecting the test equipment and performing self-testing of a transmit chain with a predetermined load value connected, wherein the self-testing routes a signal from the RF chipset internal modem through a power amplifier, duplexer, first coupler, switch, second coupler, and radio frequency (RF) integrated circuit (IC) (WTR).

2. The method of claim 1, wherein during the self-test of a transmit-receive coupled path with the self-test signal coupled from the transmit path is coupled into the feedback receiver path (FB Rx).

3. The method of claim 1, wherein the self-test in a transmit-receive coupled path and the self-test signal is routed from an internal signal generator through a duplexer and switch to a primary receiver (PRx).

4. The method of claim 1, wherein the self-test is a diversity receiver (DRx) coupled path, and the signal is routed from a signal generator through a coupler and switch to a diversity receiver (DRx).

5. An apparatus for self-testing a radio frequency (RF) chipset, comprising:
an RF chipset having an internal modem and an internal signal generator;
a processor for processing self-testing of a transmit chain;
a processor for processing self-testing of a primary receive chain; and
a processor for processing self-testing of a diversity receiver chain.

6. The apparatus of claim 5, further comprising an HDET in the RF chipset.

7. An apparatus for self-testing a radio frequency (RF) chipset, comprising:
means for loading a set of instructions into a software load station;
means for conducting reference calibration with test equipment connected; and
means for disconnecting the test equipment and performing self-testing of a transmit chain with a predetermined load value connected, wherein the self-testing routes a signal from the RF chipset internal modem through a power amplifier, duplexer, first coupler, switch, second coupler, and radio frequency (RF) integrated circuit (IC) (WTR).

8. The apparatus of claim 7, further comprising means for self-testing of a transmit-receive coupled path and means for coupling the signal from the transmit path into the feedback receiver path.

9. The apparatus of claim 7, further comprising means for routing the self-test signal from an internal signal generator through a coupler and switch to a diversity receiver (DRx).

10. A non-transitory computer readable medium containing instructions, which when executed by a processor cause the processor to perform the following steps:
loading a set of instructions into a software loading station;
conducting reference calibration with test equipment connected;
after disconnecting the test equipment, performing self-testing of a transmit chain with a predetermined load value connected, wherein the self-testing routes a signal from the RF chipset internal modem through a power amplifier, duplexer, first coupler, switch, second coupler, and radio frequency (RF) integrated circuit (IC) (WTR).

11. The non-transitory computer readable medium of claim 10, further comprising instructions the cause the processor to couple the self-test signal from the transmit path into the feedback receiver path (FB Rx).

12. The non-transitory computer readable medium of claim 10, further comprising instructions that cause the processor to route the self-test signal from an internal signal generator through a duplexer and a switch to the primary receiver (PRx).

13. The non-transitory computer readable medium of claim 10, further comprising instructions that cause the processor to route the self-test signal from the signal generator through a coupler and switch to a diversity receiver.
